(19) United States
(12) Patent Application Publication
(10) Pub. No.: US 2010/0126832 A1
(43) Pub. Date: May 27, 2010

(54) REINFORCED CLEANING BLADE AND METHOD OF MANUFACTURING THEREOF

(75) Inventor: Brett Edwin DeVries, Comstock Park, MI (US)

Correspondence Address: FITCH EVEN TABIN & FLANNERY, 120 SOUTH LASALLE STREET, SUITE 1600, CHICAGO, IL, 60603-3406, US

(73) Assignee: FLEXIBLE STEEL LACING COMPANY, Downers Grove, IL (US)

(21) Appl. No.: 12/375,522

(22) PCT Filed: Jul. 25, 2007
(86) PCT No.: PCT/US2007/074356

§ 371 Date: Jan. 13, 2010

Related U.S. Application Data
(60) Provisional application No. 60/820,732, filed on Jul. 28, 2006.

(51) Int. Cl. B65G 45/12; B29C 39/10

(52) U.S. Cl. 198/497; 264/275

(57) ABSTRACT

A reinforced conveyor belt cleaning blade is provided. In one form, the reinforced cleaning blade includes a blade body and a metal insert that is of a substantially constant cross-sectional configuration extending between the ends thereof. The ends are surrounded by molded material of the blade body so that the blade body and insert have a secure connection therebetween. The preferred insert is a formed sheet metal member that has smooth surfaces extending along its length without projections or sharp corners. In another aspect, a method of manufacturing a conveyor belt cleaning blade is provided including placing a metallic insert for the cleaning blade in a mold and molding the body of the cleaning blade with polymeric material extending completely around ends of the insert. Preferably, the insert is magnetically held in position in the mold such as on a rail on which magnets are mounted.

### FIELD OF THE INVENTION

The invention relates to cleaning blades for conveyor belts and, more particularly, to reinforcement inserts for cleaning blades and methods of manufacturing reinforced cleaning blades.

### BACKGROUND OF THE INVENTION

Cleaning blades for conveyor belts are known that are mounted to elongate support members or poles extending under or adjacent a conveyor belt with the tip of the blade engaged with the belt for scraping material therefrom. Certain cleaners are specifically designed for engaging the conveyor belt as it travels about the head pulley and are called primary cleaners versus those secondary cleaners that engage under the conveyor belt during its return run. In many of these primary cleaner systems, the cleaning blade is mounted to an upstanding flange attached to the support pole adjacent to the head pulley such as shown in the applicant's assignee's U.S. Design Pat. No. D482,508.

The blade bodies of primary cleaners such as of that in the '508 patent extend along the width of the conveyor belt and have a curved configuration for engaging the belt at a tip end portion thereof. The base portion of the blade body at the lower end is typically thicker or wider for providing additional support where the blade is mounted to the support pole. In addition, as shown in the '508 patent, an extruded support member or insert can be provided in the base portion at the slot opening thereof. As shown in FIG. 6, this aluminum insert is provided with a convex configuration including a number of projections and sharp corners to provide a secure connection between the blade body and the insert, particularly during use when exposed to scraping and impact forces. However, this complexly configured aluminum insert has an undesirably high cost associated with the extrusion manufacturer thereof. Accordingly, there is a need for an insert for cleaning blade bodies that can be manufactured economically.

### SUMMARY OF THE INVENTION

In accordance with one aspect of the present invention, a reinforced conveyor belt cleaning blade is provided including a blade body and a metal insert that is of a substantially constant cross-sectional configuration extending between ends thereof. The ends are surrounded by the molded material of the blade body so that the blade body and insert have a secure connection therebetween. The preferred insert is a formed or bent sheet metal member. The formed sheet metal member is very economical to a manufacturer. In addition, the preferred insert has smooth surfaces extending along its length without projections or sharp corners such as extruded into the prior, more costly aluminum insert.

In another aspect, a method of manufacturing a conveyor belt cleaning blade is provided including placing a metallic insert for the cleaning blade in a mold and molding the body of the cleaning blade with polymeric material extending completely around ends of the metallic insert.

In one form, the metallic insert is magnetically held at a predetermined position in the mold. Preferably, the insert is magnetically held by supporting the insert on a rail on which magnets are mounted.

In another form, the method includes bending the insert to a predetermined configuration prior to placing the insert in the mold.

### BRIEF DESCRIPTION OF THE DRAWINGS

FIG. 1 is a cross-sectional view of a cleaning blade showing a blade body having an insert molded therein;

FIG. 2 is an elevational view of the cleaning blade of FIG. 1 showing a faceted surface thereof.

FIG. 3 is an enlarged elevational view of the insert showing an upper flat portion and depending leg portion thereof;

FIG. 4 is a plan view of a mold rail for use in the mold for forming the blade of FIG. 1;

FIG. 5 is an enlarged flat, fragmentary elevational view of the rail of FIG. 4 showing magnets fixed thereto; and

FIG. 6 is a cross-sectional view of a prior cleaning blade including an extruded aluminum insert.

### DETAILED DESCRIPTION OF THE PREFERRED EMBODIMENTS

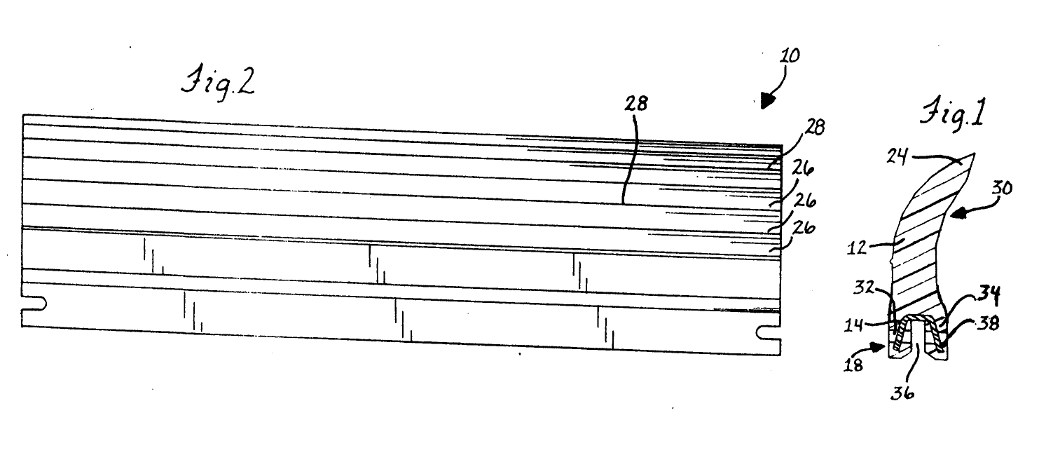

In FIGS. 1 and 2, a cleaning blade 10 having a body 12 of polymeric material and an insert 14 of metallic material is shown. The cleaning blade body 12 has a configuration similar to the configuration of prior cleaning blade 16 shown in FIG. 6 provided by applicant's assignee herein. The main differences reside in the respective base portions 18 and 20 thereof and, more particularly, with respect to the respective metallic inserts 14 and 22 thereof.

In this regard, the blade body 12 has an upper tip end portion 24 that is curved for engaging the conveyor belt as it extends around the head pulley such as when the blade 10 is used as a primary cleaner. As can be seen in FIG. 2, the blade has a facetted outer surface including a series of flat surface portions 26 with corners or sharp break lines 28 formed therebetween. The inner surface 30 of the blade body 12 that faces the head pulley and belt traveling thereabout has a similar faceted configuration. Other configurations for the corresponding inner and outer surfaces 26 and 30 could be provided. The lower base portion 18 has a slightly greater width than the remainder of the blade body 12 and has the insert 14 embedded therein such as during the molding process, as will be described hereinafter.

The base portion 18 has depending leg portions 32 and 34 spaced to form a open ended slot opening 36 therebetween. As is known, the slot 36 opens downwardly and is adapted to receive an upstanding plate or flange attached or welded to the support pole extending along and adjacent to the head pulley, for instance. The blade body 12 is also provided with a series of laterally extending throughbores 38 for receiving mounting pins or bolts that affix the cleaning blade to the upstanding flange of the support pole.

To provide the blade 10 with sufficient stiffness, particularly at the base portion 18 thereof where it is mounted to the support pole, a metallic insert 14 is provided, as shown in FIGS. 1 and 3. The present insert 14 is of low cost construction and provides manufacturing efficiencies over the manufacturer of the prior blade body 16 along with its extruded aluminum insert 22. In this regard, the insert 14 has a fairly simple construction being of substantially constant cross-sectional thickness extending between ends 40 and 42 thereof. The low cost insert 14 is molded in the blade body 12 so that the ends 40 and 42 are disposed within and surrounded by the molded material of the base body 12. The molded material is a polymeric material such as polyurethane.

Rather than an extrusion similar to insert 22 having various rib projections 44 and sharp angled corners 46 along its surfaces, the insert 14 extends lengthwise in the blade body 12 and has substantially smooth upper and lower surfaces 46 and 48 extending along its length so that ribs 44 and corners 46 such as in the extruded prior insert 22 are avoided. Instead of relying on projections 44 and sharp corners 46 to provide increased bonding area between the urethane of the blade body 16 and the extruded insert 22, the insert 14 has both of the ends 40 and 42 embedded completely within the blade body 12, and specifically the leg portions 32 and 34 thereof. In this regard, the preferred insert 14 has a generally inverted U-shape configuration. As illustrated, the insert 14 has an upper flat portion 50 and depending side leg portions 52 and 54 that extend from the upper portion 50 to the insert ends 40 and 42. The upper flat portion 50 extends in the base portion 44 across the upper end of the slot opening 36. The leg portions 52 and 54 extend in the corresponding leg portions 32 and 34 of the blade body base portion 34. With the insert ends 40 and 42 completely surrounded by molded polymeric material, there is molded material below the leg ends 40 and 42, as can be seen in FIG. 1. In addition, the insert legs 52 and 54 are completely embedded and surrounded by molded polymeric material in the corresponding leg portions 32 and 34. Accordingly, while there is a sacrifice in the resistance to sheer forces at the interface of the smooth surfaces 46 and 48 of the insert and the molded material of the blade body 12 versus the ribbed and sharply contoured extruded insert 42, the provision of the leg ends 40 and 42 completely embedded in the blade body 12 with molded material below the leg ends 40 and 42 provides the insert 14 with a secure connection to the blade body 12 and resistance to separation therefrom during scraping operations with the cleaning blade 10 herein.

The preferred and illustrated insert 14 is a bent or formed sheet metal member such as of a steel material. As mentioned, there is a substantially constant thickness between the upper and lower surfaces 46 and 48 as they extend along the upper flat portion 50 and the leg portions 52 and 54 of the elongate insert 14. The leg portions 52 and 54 are bent from the upper portion 50 so that there are radiused or curved transitions along the surfaces 46 and 48 between the upper portion 50 and the leg portions 52 and 54. As can be seen in FIG. 3, the legs 52 and 54 extend downwardly from the upper portion 50 and taper away from each other to the ends 40 and 42. The sheet metal can be approximately 7 gage or approximately 0.18 inch in thickness between the surfaces 46 and 48 thereof.

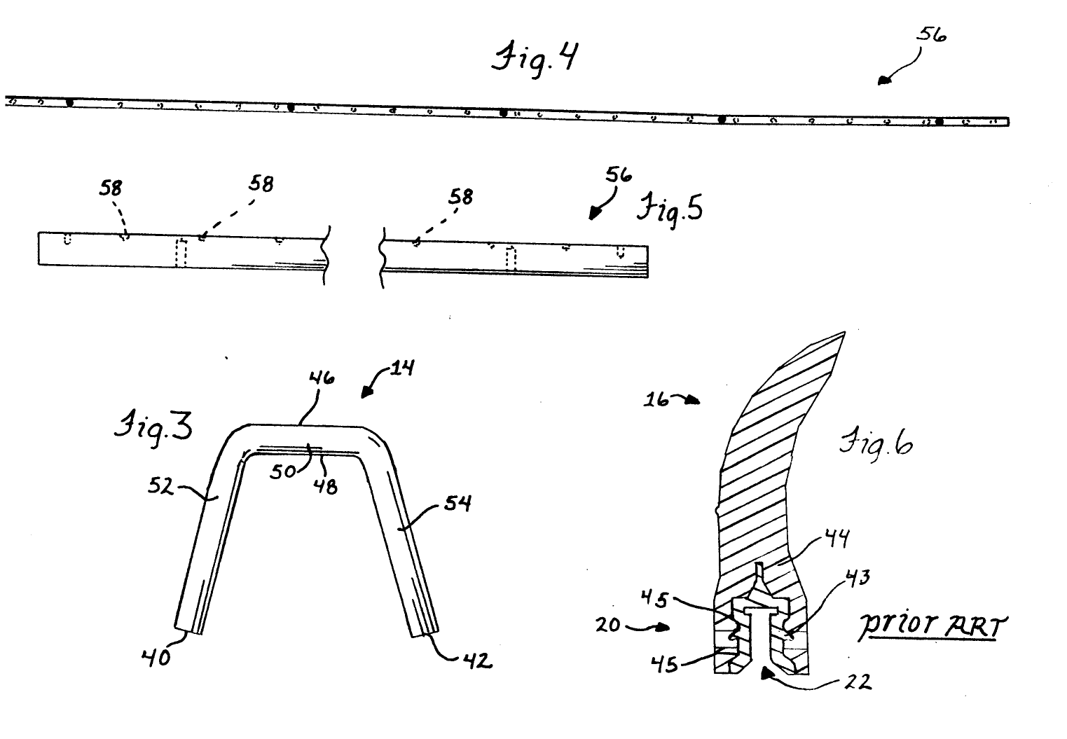

To form the blade body with the insert 14 therein, the insert 14 is molded in situ with the blade body 12. In this regard, the insert 14 is placed in the mold for forming the cleaning blade body 12 and the body 12 is molded about the insert 14 such that the ends 40 and 42 are completely surrounded by the polymeric material of the cleaning blade body 12. The insert 14 is first formed to the generally inverted U-shaped configuration by bending the sheet steel member so that the leg portions 52 and 54 depend from the upper flat portion 50, as shown in FIG. 3. For securely holding the steel insert 14 in the mold, an elongate support rail 56 is provided, as shown in FIGS. 4 and 5. The support rail 56 has several magnets 58 mounted along its length so that the insert 14 is magnetically held to the rail 56.

More specifically, the elongate insert 14 is placed into the mold so that the flat upper portion 50 extends along and rests on the rail 56 with the leg portions 52 and 54 extending downwardly in the mold from the rail 56 along either side thereof. For locating the insert 14 on the rail 56, locating pins and openings can be used on the rail and the insert 14. With the insert 14 properly located on the rail 56, the magnets 58 will draw the lower surface 58 at the insert flat portion 50 down into tightly held engagement with the rail 56. The legs 52 and 54 will extend downwardly from either side of the rail 56 with their ends 40 and 42 positioned in the mold so that when the blade body is molded, molded material of the blade body leg portions 32 and 34 will extend below the insert leg ends 40 and 42, as previously has been described.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A reinforced conveyor belt cleaning blade comprising:
a blade body having a tip end portion for scraping engagement with a conveyor belt, the blade body being of a predetermined molded material; and
a reinforcing insert of a metallic material and a substantially constant cross-sectional thickness extending between ends thereof that are both disposed within and surrounded by the molded material of the blade body.

2. The reinforced cleaning blade of claim 1 wherein the insert comprises a bent sheet metal member.

3. The reinforced cleaning blade of claim 1 wherein the blade body and the insert therein have an elongate configuration, and the insert has smooth surfaces extending lengthwise therealong without projections or sharp corners.

4. The reinforced cleaning blade of claim 3 wherein the insert has an upper flat portion and side leg portions bent therefrom extending to the ends of the insert with transitions between the upper flat portion and the side leg portions being radiused.

5. The reinforced cleaning blade of claim 1 wherein the metallic material comprises a steel material.

6. The reinforced cleaning blade of claim 1 wherein the insert has a generally inverted U-shape configuration.

7. The reinforced cleaning blade of claim 1 wherein the blade body has a lower base end portion including depending leg portions and an open ended slot extending therebetween, and the insert includes leg portions completely embedded in the corresponding leg portions of the lower end portion.

8. The reinforced cleaning blade of claim 7 wherein the insert leg portions extend downwardly and away from each other to the insert ends in the corresponding leg portions of the base lower end portions so that the insert ends have molded material therebelow and the insert legs have molded material extending up along either side thereof.

9. A method of manufacturing a conveyor belt cleaning blade, the method comprising:
placing a metallic insert for the cleaning blade in a mold; and
molding a body of the cleaning blade with a polymeric material extending completely around ends of the metallic insert.

10. The method of claim 9 including magnetically holding the insert at a predetermined position in the mold.

11. The method of claim 10 wherein the insert is magnetically held by supporting the insert on a rail on which magnets are mounted.

12. The method of claim 9 wherein molding the cleaning blade body includes forming the body with the insert at lower portion thereof and polymeric material extending below the insert ends.

13. The method of claim 9 including bending the insert to a predetermined configuration prior to placing the insert in the mold.
